(19) United States
(12) Patent Application Publication
(10) Pub. No.: US 2014/0114954 A1
(43) Pub. Date: Apr. 24, 2014

(54) INCORPORATING RELATED SEARCHES BY OTHER USERS IN A SOCIAL NETWORK IN A SEARCH REQUEST

(71) Applicant: INTERNATIONAL BUSINESS MACHINES CORPORATION, Armonk, NY (US)

(72) Inventors: Judith H. Bank, Morrisville, NC (US); Liam Harpur, Skerries, Dublin (IE); Ruthie D. Lyle, Durham, NC (US); Patrick J. O'Sullivan, Ballsbridge (IE); Lin Sun, Morrisville, NC (US)

(73) Assignee: INTERNATIONAL BUSINESS MACHINES CORPORATION, Armonk, NY (US)

(21) Appl. No.: 13/658,805

(22) Filed: Oct. 23, 2012

(51) Int. Cl. G06F 17/30

(52) U.S. Cl. 707/722; 707/E17.082

(57) ABSTRACT

Provided are a computer program product, system, and method for incorporating related searches by other users in a social network in a search request. A search request is received including keywords from a searching user including a keyword to search. A determination is made of at least one other user in a trust relationship with the searching user. A determination is made of related searches submitted by the determined at least one other user having related keywords related to the keywords included in the received search request. Information is returned to the searching user on the related keywords in the related searches in response to determining that the determined at least one other submitted related searches.

### BACKGROUND OF THE INVENTION

1. Field of the Invention

The present invention relates to a computer program product, system, and method for incorporating related searches by other users in a social network in a search request.

2. Description of the Related Art

A user constructing a search request may construct their own query to search a remote Internet search engine or search content within a social network in which they participate, such as an online interactive community, e.g., FACEBOOK®, TWITTER®, LINKEDIN, etc., or an organizational social network, such as a work related social network. (FACEBOOK is a registered trademark of Facebook Inc. in the United States and other countries, TWITTER is a registered trademark of Twitter Inc. in the United States and other countries, and LINKEDIN is a registered trademark of Linkedin, LTD. in the United States and other countries).

There is a need in the art to provide techniques to allow searches to improve their searches to obtain more relevant search results.

### SUMMARY

Provided are a computer program product, system, and method for incorporating related searches by other users in a social network in a search request. A search request is received including keywords from a searching user including a keyword to search. A determination is made of at least one other user in a trust relationship with the searching user. A determination is made of related searches submitted by the determined at least one other user having related keywords related to the keywords included in the received search request. Information is returned to the searching user on the related keywords in the related searches in response to determining that the determined at least one other submitted related searches.

### BRIEF DESCRIPTION OF THE DRAWINGS

FIG. 1 illustrates a social network computing environment in which embodiments are implemented.

FIG. 2 illustrates an embodiment of an activity record.

FIG. 3 illustrates an embodiment of a search request.

FIG. 4 illustrates an embodiment of user search settings.

FIGS. 5a, 5b, and 5c illustrate an embodiment of operations to incorporate related searches by other users in a social network in a search request.

FIG. 6 illustrates an embodiment of a computer system in which embodiments may be implemented.

### DETAILED DESCRIPTION

Described embodiments provide techniques to allow a user submitting a search with keywords to have their search enhanced and supplemented based on the activity and context of a user prior to initiating the search. Described embodiments improve a basic search by ascertaining what other users would search, given the same context. A determination may be made of related activity of other users that includes activity or context related to the activity or keywords in the submitted search. These related keywords and context from the related activity, including searches, may then be incorporated into the search request to allow the searcher to have the advantage of activities, keywords and search strategies used by others in the social network that may have specific knowledge of the topic being searched. The determined related keywords may be used to search a remote Internet search engine and to search content and databases in the social network computing environment.

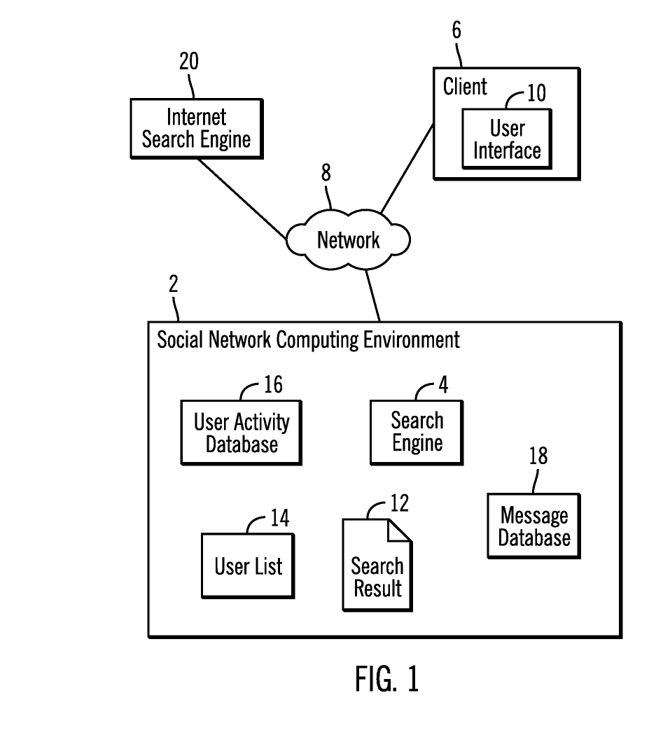

FIG. 1 illustrates an embodiment of a social network computing environment including a search engine 4 for receiving search requests from client 6 systems over a network 8. The client systems 6 may include a user interface 10 for constructing and transmitting the search requests. The search engine 4 may generate a search result page 12 to return to the requesting client 6 having information on searches performed by other users in the social network related to the submitted search request. The social network computing environment 2 includes components to implement a social networking service, and may include a user list 14 of users in the social network, a user activity database 16 having information on activities users in the user list 12 have performed, and a message database 18 including messages created and transmitted among users in the user list 12 as part of the social networking service. The social network service may comprise an open social network, such as FACEBOOK, TWITTER, LINKEDIN, etc., or a private corporate or organization network. Users in the user list 12 that participate in the social network may have a relationship of trust, such that users are willing to share their search activity with other users.

In one embodiment, the search result 12 may comprise a search constructed from keywords used by other users in the user list 14. This constructed search 12 may be submitted to a remote Internet search engine 20 over the network 8, such as a publicly available search engine, e.g., GOOGLE®, BINGO, etc. (GOOGLE is a registered trademark of Google, Inc in the U.S. and other countries and BING is a registered trademark of Microsoft Corporation in the U.S. and other countries). Alternatively, the constructed search 12 may be used to search content within the social network computing environment 2, such as the activity 16 and message 18 databases.

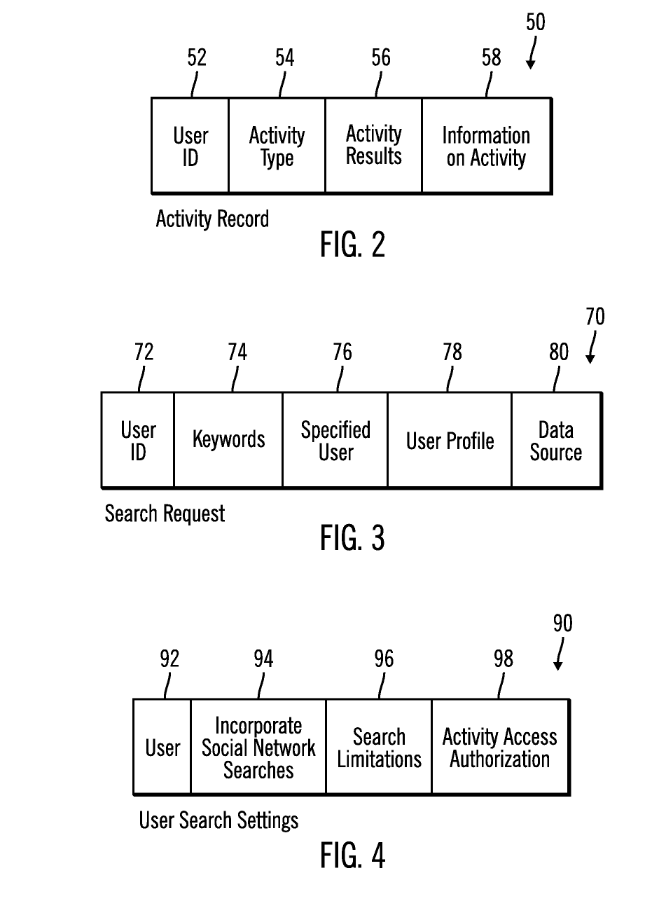

FIG. 2 provides an embodiment of an activity record 50 in the activity database 16 providing information on a user activity, which may include a user identifier (ID) 52 of the user that initiated the activity; an activity type 54, such as search, message, online transaction, content accessed from over the Internet or within the social network computing environment 2, etc.; activity results 56 from the activity, such as the search performed, content accessed, message content, etc.; and information on the activity 58, such as metadata, etc.

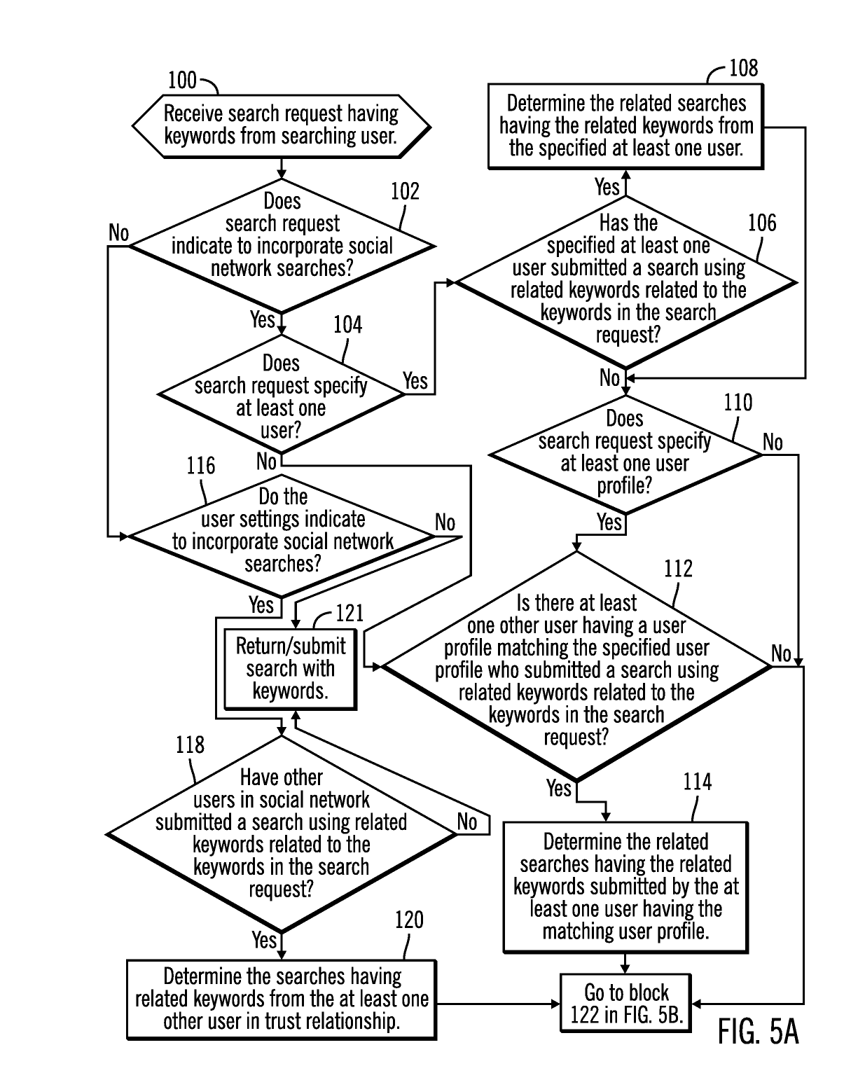

FIG. 3 provides an embodiment of a search request 70 initiated by the client 6 user interface 8 submitted to the search engine 4, which may include a user ID 72 identifying the user at the client 6 that submitted the search request 70; keywords 74 to search; an optional one or more specified users 76 indicating a user in the user list 14 to determine related search keywords submitted by the specified user 76 in a related search; an optional one or more user profiles 78 indicating a profile of users in the user list 14 to determine related search keywords submitted in related searches by users having the user profile 78; and a data source 80 for which to retrieve information related to the related keywords, such as the message database 18, user activity database 16, etc.

The searching user may specify a user 76 when the searching user believes that one or more specified users 76 have particular expertise in the area or topic being searched, such that the searching user would like to utilize related search keywords the specified users submitted for related searches. The searching user may specify a user profile 78 that the searching user believes particularly relevant to the topic being searched, so that the searching user can utilize related search keywords submitted by the users having the believed relevant user profile. Other criteria may be used to determine users who are likely to submit searches relevant to the search request 70.

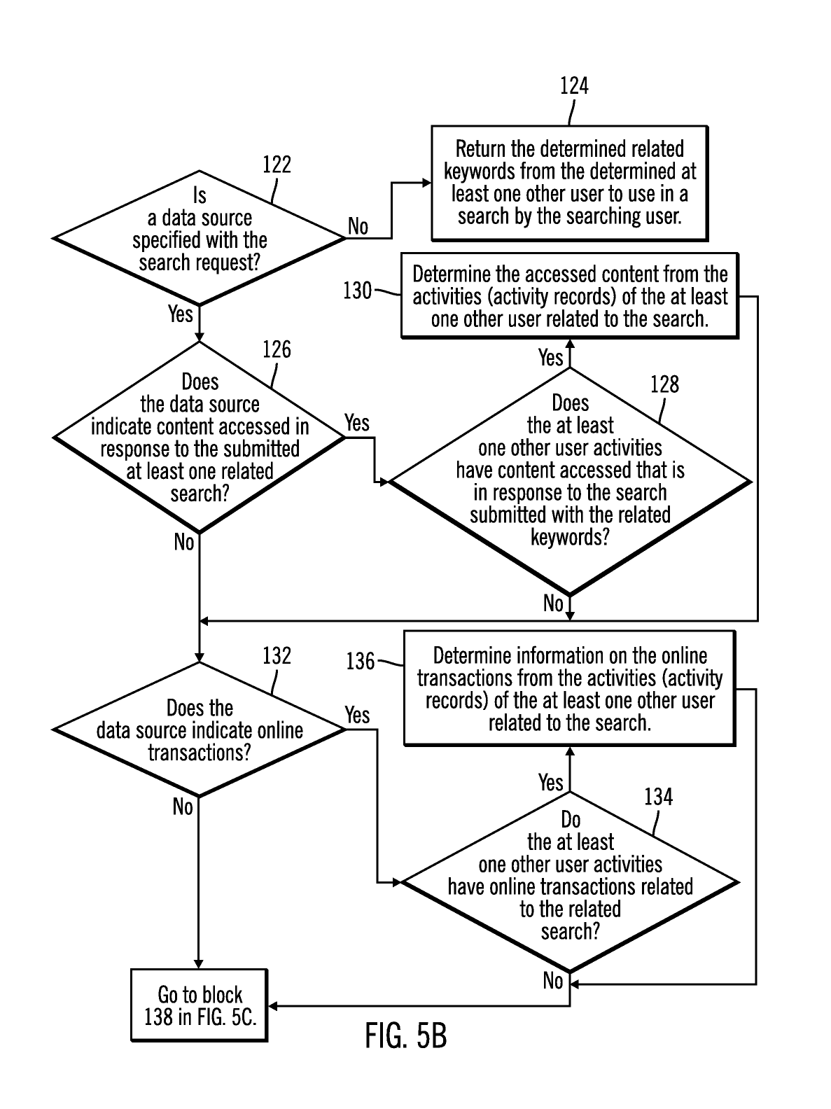

FIG. 4 provides an embodiment of user search settings 90 which may include a user ID 92 identifying the user to which the settings apply; an incorporate social network searching 94 setting specifying whether searches from other users should be considered to incorporate in a search request submitted by the user 92; search limitations indicating a limitation on the activity to search, such as a temporal limit to not search activity older than the limit or a cache size limit indicating a maximum number of user activities to cache to be available for searching; and activity access authorization 98 indicating whether the user 2 wants to allow other users to search their activity, searches, and messages and other specified items when submitting search requests.

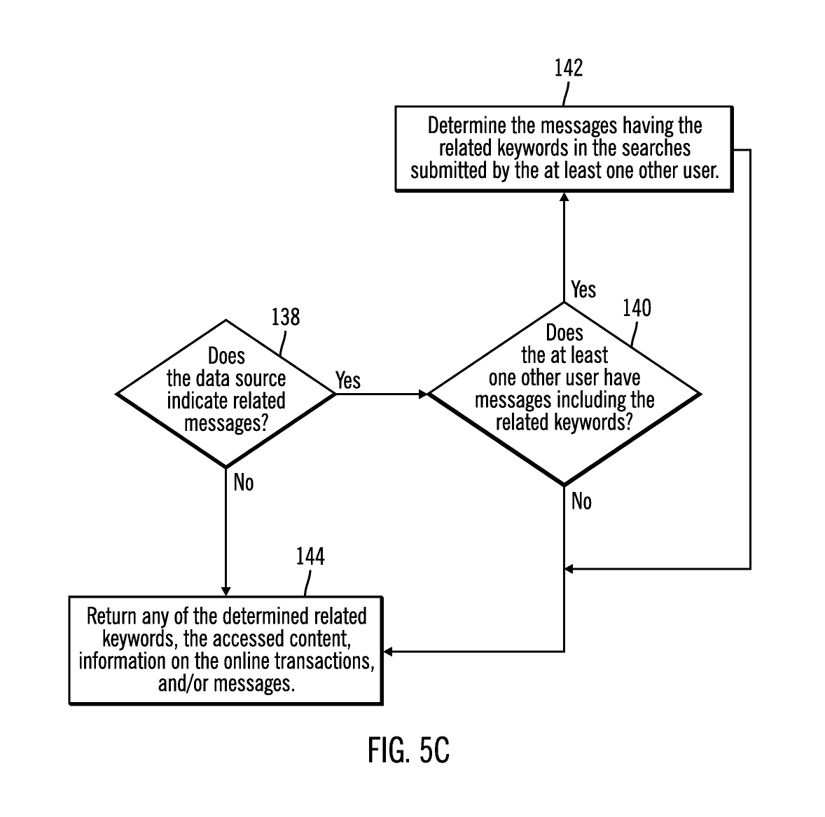

FIGS. 5a, 5b, and 5c illustrate an embodiment of operations performed by the search engine 4 to process to a search request from a searching user that may involve determining searches of other users in the trust relationship or social network to use to supplement search request. Upon receiving (at block 100) a search request 70 having keywords from a searching user at a client 6 system, the search engine 4 determines (at block 102) whether the search request 70 indicates to incorporate social network searches, such as in the specified user 76 and user profile 78 fields. If so, and if (at block 104) the received search request 70 specifies at least one other user 76 in a trust relationship, e.g., in the user list 14 of the social network service, then the search engine 4 determines (at block 106) whether the specified at least one user 76 submitted a related search using related keywords related to the keywords 74 in the search 70. This operation may involve looking at activity records 50 of the specified at least one user 76 to determine keywords in submitted searches. The search engine 4 may use a data mining or other technique to determine the relationship or association of the search keywords 74 with the keywords the specified user 76 submitted in searches indicated in the activity records 50 to determine related keywords from searches submitted by the specified user 76. If (at block 106) there are related keywords from related searches by the specified at least one other user 76, then the search engine 4 determines (at block 108) the related searches having the related keywords submitted by the specified at least one user 76.

From block 108 or the no branch of block 106 (if the specified users 76 did not submit related searches having related keywords), the search engine 4 determines (at block 110) whether the search request 70 also specifies at least one user profile 78. From the yes branch of block 110 (if a user profile 78 is specified) or from the no branch of block 104 (when there is only a user profile 78 specified), the search engine 4 determines (at block 112) whether there is at least one other user in a trust relationship, e.g., in the user list 14, having a user profile matching the specified user profile 78 that also submitted a related search using related keywords related or associated with the search keywords 74. A matching user profile may not comprise an exact match, but a match according to data mining, association and fuzzy search techniques. As discussed, keywords may be determined to be related based on data mining or other association techniques. If (from the yes branch of block 112) there is such a user, then the search engine 4 determines (at block 114) the related searches having the related keywords submitted by the at least one user having the matching user profile.

If (at block 102) the search request 70 does not indicate to incorporate social network searches by other users, then the search engine 4 determines (at block 116) whether the user settings 90 indicate to incorporate social network searching 94 (FIG. 4). If so, then the search engine 4 determines (at block 118) whether users in the social network have submitted a related search using related keywords related to the search request keywords 74. In one embodiment, the search engine 4 may consider the searches of all users in the user list 14 in the trust relationship. In an alternative embodiment, the search engine 4 may use data mining and statistical techniques to determine other users whose activity is related or associated with the activity of the searching user. In such an embodiment, the search engine 4 determines a degree of association of the activities of the other users in the trust relationship, e.g., user list 14, with the activities of the searching user. The search engine 4 then determines at least one other user whose activities have a degree of association with the activities of the searching user that exceeds a minimum threshold of support and confidence. In this case, the determined at least one other user comprises the user having activity characteristics that have a degree of association or relation to the activities of the searching user.

If (from the yes branch of block 118) there are related keywords from searches by the determined other users, then the search engine 4 determines (at block 120) the searches having the related keywords from the at least one other user the trust relationship (e.g., in user list 14). From the no branch of block 118 (when no other users have submitted searches with related keywords) or no branch of block 116 (if there has been no indication in the user settings 90 or the search request to incorporate searches from other users in the social network), the search engine 4 returns to the searching user or submits (at block 121) the search with only the keywords 74 from the search request 70 because at this block social network searches are not to be incorporated. The search engine 4 may submit the search to search databases 16, 18 in the social network computing environment 2 or to the external Internet search engine 20. Alternatively, the search engine 4 may return the submitted search with the keywords 74 to the searching user at the client user interface 8 to select whether to edit and submit.

After determining searches from other users having related keywords (from block 110, 112, and/or 120), control proceeds to block 122 in FIG. 5b where the search engine 4 determines (at block 122) whether a data source 80 has been specified in the search request 70. If not, then the search engine 4 returns (at block 124) the determined related keywords from the determined at least one other user to use in a search by the searching user. The search engine 4 may submit a search including the related keywords to the Internet search engine 20 or to search the databases 16, 18 in the social network computing environment 2, or return the related keywords to the searching user in the client user interface 8 to allow the user to further edit and submit.

If (at block 122) the search request 70 specifies a data source 80, such as downloaded online content, messages, and other activities, then the search engine 4 determines (at block 126) whether the data source 80 indicates content accessed by the at least one other user in response to a related search, such as pages downloaded from cites accessed as part of the related search. If so, then the search engine 4 determines (at block 128) whether the at least one other user's activities have content accessed that is in response to the related search submitted with the related keywords. For instance, the search engine 4 may search the activity records 50 for the at least one other user to determine search activity types 54, and then look for activity results 56 indicating the search results, and then further consider download activity records 50 for a download activity 56 that downloaded content from web addresses, e.g., Universal Resource Locators (URLs), identified in the search activity results 56. If such content was accessed, then the search engine 4 determines (at block 130) the accessed content from the related searches identified in the search activities (activity records).

From blocks 126, 128 or 130, the search engine 4 determines (at block 132) whether the data source 80 indicates online transactions. If so, then the search engine 4 determines (at block 134) whether the activities (activity records 50) of at least one other user indicate online transactions related to the search submitted with the related keywords. For instance, the search engine 4 may look for activity records 50 for the at least one other users that indicate online transactions as an activity type 54 that are related to the search results. This may be determined by determining online transactions that occur at URLs indentified in related search activity results 56. If (at block 134) there are such online transactions, then the search engine 4 determines (at block 136) information on the online transactions from the related search activities (activity records 50) of the at least one other user.

After considering online transactions from block 132, 134 or 136, control proceeds to block 138 in FIG. 5c to determine whether the data source 80 indicates messages. If so, then the search engine 4 determines (at block 140) whether the at least one other user has messages in the message database 18 including the related keywords. If so, then the search engine 4 determines (at block 142) the messages in the message database 18 having the related keywords in the related searches submitted by the at least one other user. The search engine 4 may determine for each of the at least one other user the messages having the related keywords submitted by such user or include the messages of the other users having related keywords submitted by all the other users.

After determining any other activity information to gather from the no branch of block 138, the no branch of block 140 or block 142, the search engine 4 returns (at block 144) any of the determined related keywords, the accessed content, information on the online transactions, and/or messages to the search user. The searching user at the user interface 8 may then select to submit the message including the related keywords from the at least one other user and review the additional determined content associated with the related keywords. Alternatively, the search engine 4 may submit the search request incorporating the related keywords to the internet search engine 20 or to databases 16, 18 in the social network computing environment 2.

With the described embodiments, a searching user submitting a search request in a social network environment may incorporate the searches of other having related keywords related to the keywords submitted with the search request. This allows the searching user to obtain the benefit of related searches by selected users or users having a selected user profile who are believed to have particular knowledge in the area being searched. The related searches have keywords that are related to the search request keywords. Further, with the described embodiments, the searching user may obtain information on activities of other users related to the search request, including content other users have downloaded when performing related searches, online transactions other users have performed related to the related searches, and messages having the related keywords. This allows the searching user to not only enhance a search request with related searches by other users in the social network but to also gather additional information and content from the social network environment on activities of other users related to their search.

The described operations may be implemented as a method, apparatus or computer program product using standard programming and/or engineering techniques to produce software, firmware, hardware, or any combination thereof. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The illustrated operations of the figures show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

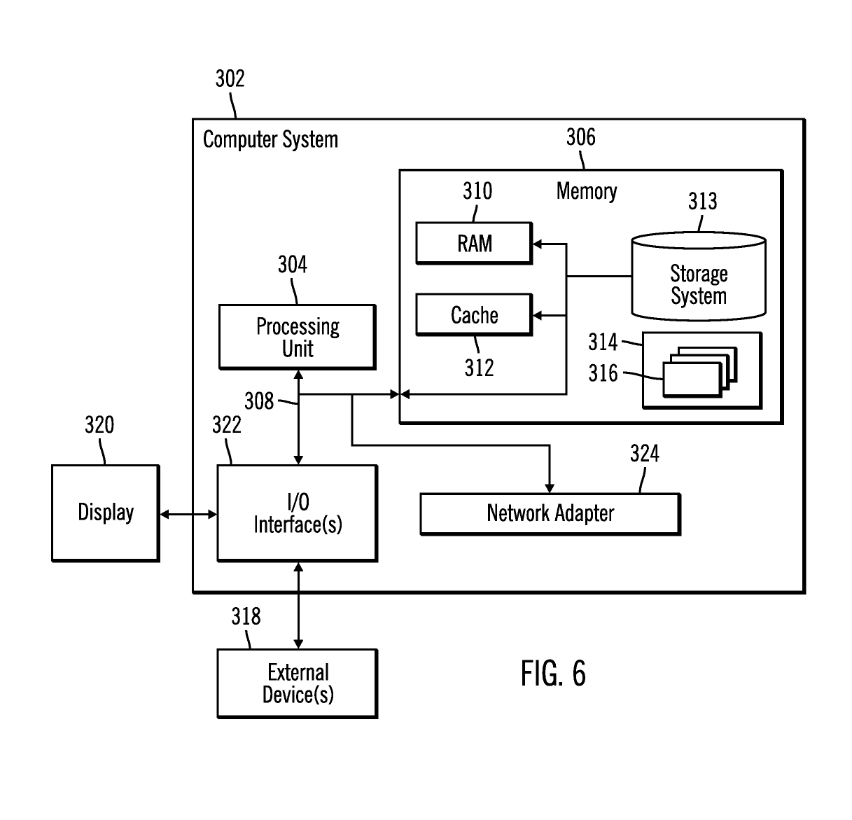

The client system 6 and the elements of the social network computing environment of FIG. 1, including the user activity database 16, search engine 4, message database 18, and the user list 14, may be implemented in one or more computer systems, such as the computer system 302 shown in FIG. 6. If the components of the social network computing environment 2 are implemented in multiple systems, then the systems may communicate over the network 8. Computer system/server 302 may be described in the general context of computer system executable instructions, such as program modules, being executed by a computer system. Generally, program modules may include routines, programs, objects, components, logic, data structures, and so on that perform particular tasks or implement particular abstract data types. Computer system/server 302 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, the computer system/server 302 is shown in the form of a general-purpose computing device. The components of computer system/server 302 may include, but are not limited to, one or more processors or processing units 304, a system memory 306, and a bus 308 that couples various system components including system memory 306 to processor 304. Bus 308 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 302 typically includes a variety of computer system readable media. Such media may be any available media that is accessible by computer system/server 302, and it includes both volatile and non-volatile media, removable and non-removable media.

System memory 306 can include computer system readable media in the form of volatile memory, such as random access memory (RAM) 310 and/or cache memory 312. Computer system/server 302 may further include other removable/non-removable, volatile/non-volatile computer system storage media. By way of example only, storage system 313 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 308 by one or more data media interfaces. As will be further depicted and described below, memory 306 may include at least one program product having a set (e.g., at least one) of program modules that are configured to carry out the functions of embodiments of the invention.

Program/utility 314, having a set (at least one) of program modules 316, may be stored in memory 306 by way of example, and not limitation, as well as an operating system, one or more application programs, other program modules, and program data. Each of the operating system, one or more application programs, other program modules, and program data or some combination thereof, may include an implementation of a networking environment. The components of the computer 2 may be implemented as program modules 316 which generally carry out the functions and/or methodologies of embodiments of the invention as described herein. The components 12, 14, 16, and 18 of the content analytics system 2 may be implemented in one or more computer systems 302, where if they are implemented in multiple computer systems 302, then the computer systems may communicate over a network.

Computer system/server 302 may also communicate with one or more external devices 318 such as a keyboard, a pointing device, a display 320, etc.; one or more devices that enable a user to interact with computer system/server 12; and/or any devices (e.g., network card, modem, etc.) that enable computer system/server 302 to communicate with one or more other computing devices. Such communication can occur via Input/Output (I/O) interfaces 322. Still yet, computer system/server 302 can communicate with one or more networks such as a local area network (LAN), a general wide area network (WAN), and/or a public network (e.g., the Internet) via network adapter 324. As depicted, network adapter 324 communicates with the other components of computer system/server 302 via bus 308. It should be understood that although not shown, other hardware and/or software components could be used in conjunction with computer system/server 302. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for generating search requests, the computer program product comprising a computer readable storage medium having computer readable program code embodied therein that executes to perform operations, the operations comprising:
receiving a search request including keywords from a searching user including a keyword to search;
determining at least one other user in a trust relationship with the searching user;
determining related searches submitted by the determined at least one other user having related keywords related to the keywords included in the received search request; and
returning, to the searching user, information on the related keywords in the related searches in response to determining that the determined at least one other submitted related searches.

2. The computer program product of claim 1, wherein the operations further comprise:
using the related keywords from the determined at least one related search to perform a search.

3. The computer program product of claim 2, wherein the operations of receiving the search request, determining the related searches, and the returning the information on the related keywords are performed in a social network computing environment and wherein performing the search comprises submitting the search to an Internet search engine remote with respect to the computing environment.

4. The computer program product of claim 1, wherein the relationship of trust comprises an online social network including the searching user and the determined at least one other user, wherein the searching user and the at least one other user have granted each other authorization to perform the determining of the related searches and presenting the information on the related keywords from the related searches.

5. The computer program product of claim 1, wherein the operations further comprise:
determining that the searching user has indicated a selected user profile for the search request, wherein the determining the at least one other user comprises determining at least one other user having a user profile consistent with the selected user profile.

6. The computer program product of claim 1, wherein the operations further comprise:
determining that the searching user has indicated a selected user for the search request, wherein the determined at least one other user comprises the selected user.

7. The computer program product of claim 6, wherein the search request includes a query statement including the related keywords and the selected user.

8. The computer program product of claim 1, wherein the operations further comprise:
determining that the searching user has indicated a data source for the search request;
determining activities of the determined at least one other user in the specified data source; and
returning, to the searching user, information on the determined activities.

9. The computer program product of claim 8, wherein the indicated data source comprises content accessed as part of a submitted search, wherein the determining the activities of the determined at least one other user comprises determining content the determined least one other user accessed in response to the submitted related search, and wherein the returned information comprises the determined content.

10. The computer program product of claim 8, wherein the indicated data source comprises online transactions, wherein the determining the activities of the determined at least one other user comprises determining online transactions the determined at least one other user performed related to the related search, and wherein the returned information comprises information on the determined online transactions.

11. The computer program product of claim 8, wherein the indicated data source comprises a message store, wherein the determining the activities of the at least one other user comprises determining messages for the at least one other user including the related keywords, and wherein the returned information comprises information on the determined messages.

12. The computer program product of claim 1, wherein the operations further comprise:
maintaining activity information on activities of users in the trust relationship, wherein determining the at least one other user comprises:
determining a degree of association of the activities of the users in the trust relationship with the activities of the searching user; and
determining at least one user having the degree of association that exceeds a threshold, wherein the determined at least one other user comprises the determined at least one user whose activities have the degree of association with the activities of the searching user that exceed the threshold.

13. The computer program product of claim 12, wherein the activities comprise at least one of submitted searches, web sites visited, and online activities.

14. A system for generating search requests, comprising:
a processor;
a computer readable storage medium having computer readable program code executed by the processor to perform operations, the operations comprising:
receiving a search request including keywords from a searching user including a keyword to search;
determining at least one other user in a trust relationship with the searching user;
determining related searches submitted by the determined at least one other user having related keywords related to the keywords included in the received search request; and
returning, to the searching user, information on the related keywords in the related searches in response to determining that the determined at least one other submitted related searches.

15. The system of claim 14, wherein the operations further comprise:
using the related keywords from the determined at least one related search to perform a search.

16. The system of claim 15, wherein the operations of receiving the search request, determining the related searches, and the returning the information on the related keywords are performed in a social network computing environment and wherein performing the search comprises submitting the search to an Internet search engine remote with respect to the computing environment.

17. The system of claim 14, wherein the operations further comprise:
determining that the searching user has indicated a selected user profile for the search request, wherein the determining the at least one other user comprises determining at least one other user having a user profile consistent with the selected user profile.

18. The system of claim 14, wherein the operations further comprise:
determining that the searching user has indicated a selected user for the search request, wherein the determined at least one other user comprises the selected user.

19. The system of claim 14, wherein the operations further comprise:
determining that the searching user has indicated a data source for the search request;
determining activities of the determined at least one other user in the specified data source; and
returning, to the searching user, information on the determined activities.

20. The system of claim 19, wherein the indicated data source comprises online transactions, wherein the determining the activities of the determined at least one other user comprises determining online transactions the determined at least one other user performed related to the related search, and wherein the returned information comprises information on the determined online transactions.

21. The system of claim 14, wherein the operations further comprise:
maintaining activity information on activities of users in the trust relationship, wherein determining the at least one other user comprises:
determining a degree of association of the activities of the users in the trust relationship with the activities of the searching user; and
determining at least one user having the degree of association that exceeds a threshold, wherein the determined at least one other user comprises the determined at least one user whose activities have the degree of association with the activities of the searching user that exceed the threshold.

22. A method performed by components of a computer system, comprising:
receiving from a searching user computer a search request including keywords from a searching user including a keyword to search;
determining at least one other user in a trust relationship with the searching user;
determining related searches submitted by the determined at least one other user having related keywords related to the keywords included in the received search request; and
returning, to the searching user computer, information on the related keywords in the related searches in response to determining that the determined at least one other submitted related searches.

23. The method of claim 22, further comprising:
using the related keywords from the determined at least one related search to perform a search.

24. The method of claim 23, wherein the operations of receiving the search request, determining the related searches, and the returning the information on the related keywords are performed in a social network computing environment and wherein performing the search comprises submitting the search to an Internet search engine remote with respect to the computing environment.

25. The method of claim 22, further comprising:
determining that the searching user has indicated a selected user profile for the search request, wherein the determining the at least one other user comprises determining at least one other user having a user profile consistent with the selected user profile.

26. The method of claim 22, further comprising:
determining that the searching user has indicated a selected user for the search request, wherein the determined at least one other user comprises the selected user.

27. The method of claim 22, further comprising:
determining that the searching user has indicated a data source for the search request;
determining activities of the determined at least one other user in the specified data source; and
returning, to the searching user, information on the determined activities.

28. The method of claim 27, wherein the indicated data source comprises online transactions, wherein the determining the activities of the determined at least one other user comprises determining online transactions the determined at least one other user performed related to the related search, and wherein the returned information comprises information on the determined online transactions.

29. The method of claim 22, further comprising:
maintaining activity information on activities of users in the trust relationship, wherein determining the at least one other user comprises:
determining a degree of association of the activities of the users in the trust relationship with the activities of the searching user; and
determining at least one user having the degree of association that exceeds a threshold, wherein the determined at least one other user comprises the determined at least one user whose activities have the degree of association with the activities of the searching user that exceed the threshold.
